(19) United States
(12) Patent Application Publication
(10) Pub. No.: US 2020/0137050 A1
(43) Pub. Date: Apr. 30, 2020

(54) METHOD AND SYSTEM FOR APPLYING NEGATIVE CREDENTIALS

(71) Applicant: JPMorgan Chase Bank, N.A., New York, NY (US)

(72) Inventors: Subhadaa Reddimasi, Newark, DE (US); Brian Flanagan, Wilmington, DE (US)

(21) Appl. No.: 14/753,487

(22) Filed: Jun. 29, 2015

Related U.S. Application Data
(60) Provisional application No. 62/018,067, filed on Jun. 27, 2014.

(51) Int. Cl. H04L 29/06; H04L 29/08

(52) U.S. Cl. CPC H04L 63/0861; H04L 63/1441; H04L 67/306

(57) ABSTRACT

The invention relates to a system and method for applying negative credential to identify fraudulent activity. The system receives a communication during the communication session, wherein the communication comprises a transaction request initiated by the computer; collects credential data associated with at least one of: the customer device, biometric data of a customer associated with the transaction request, and data associated with the transaction request; compares the collected credential data to one or more negative fraud credentials, wherein the negative fraud credentials comprise biometric data associated with previously identified fraudulent transactions; determines whether the transaction request is identified as a fraudulent transaction, at least based on the comparison; generates an alert indicating that the transaction request is associated with fraud; and prevents the transaction associated with the transaction request from being conducted.

### CROSS REFERENCE TO RELATED APPLICATIONS

This application claims priority to provisional application, U.S. patent application No. 62/018,067 (Attorney Docket No. 72167.000873), filed Jun. 27, 2014, the contents of which are incorporated herein by reference in its entirety.

### FIELD OF THE INVENTION

The present invention generally relates to applying negative credentials (e.g., biometrics) to accurately identify fraudsters and fraudulent activity.

### BACKGROUND OF THE INVENTION

Fraud detection is a process that conventionally includes, monitoring, identifying, and further considering numerous transactions that are conducted between a person, such as a customer, and an associated service entity (e.g., a financial institution, merchant, or company) in order to determine fraudulent activity. For example, fraud may involve an attempt to use false information or conduct unauthorized activity, such as unauthorized purchases or identity theft. Fraud detection may further involve tracking and subsequently processing, large volumes of data corresponding to the observed transactions, in order to identify patterns associated with fraud behavior. Therefore, fraud detection can be a labor intensive process, if performed manually. Additionally, current fraud detection mechanisms may aggressively apply detection parameters, which may lead to errors, inaccuracies, and frequent false positives. Therefore, conventional fraud detection systems may cause customers in good standing to become identified as potential fraudsters.

Fraud may also affect transactions that require authentication of the customer, in instances where a fraudster has compromised the customer's identity and identification information. Authentication generally involves verifying a user's identity. For online interactions, for example, a username identifies the user and the password authenticates that the user is whom he claims to be. By entering the proper username and password combination, the user is authenticated into a system. However, passwords can be stolen in identity theft, guessed and misused by fraudsters and other unauthorized users. This is especially problematic when financial and personal information are accessed without the user's permission or knowledge. Therefore, effective fraud detection schemes may be necessary.

Other drawbacks may also be present.

### SUMMARY OF THE INVENTION

An embodiment of the present invention is directed to a system, comprising: a network, a user device, wherein the user device is communicatively coupled to the network; a processor, wherein the processor is communicatively coupled to the network; and a memory comprising computer-readable instructions which when executed by the processor cause the processor to perform the steps comprising: establishing, via the network, a communication session with the user device; receiving, via the network and using a programmed computer processor, a communication during the communication session, wherein the communication comprises a transaction request initiated by the computer; collecting, via the network and using the programmed computer processor, credential data associated with at least one of: the customer device, biometric data of a customer associated with the transaction request, and data associated with the transaction request; comparing, using the programmed computer processor, the collected credential data to one or more negative fraud credentials, wherein the negative fraud credentials comprise biometric data associated with previously identified fraudulent transactions; determining, using the programmed computer processor, whether the transaction request is identified as a fraudulent transaction, at least based on the comparison; upon determining that the transaction is fraudulent, generating, using the programmed computer processor, an alert indicating that the transaction request is associated with fraud; preventing, using the programmed computer processor, the transaction associated with the transaction request from being conducted; and updating, using the programmed computer processor, the one or more negative fraud credentials with the collected credential data.

An automated computer implemented method for applying negative credentials, wherein the method is executed by a programmed computer processor which communicates with a user via a network, comprises the steps of: establishing, via the network, a communication session with the user device; receiving, via the network and using a programmed computer processor, a communication during the communication session, wherein the communication comprises a transaction request initiated by the computer; collecting, via the network and using the programmed computer processor, credential data associated with at least one of: the customer device, biometric data of a customer associated with the transaction request, and data associated with the transaction request; comparing, using the programmed computer processor, the collected credential data to one or more negative fraud credentials, wherein the negative fraud credentials comprise biometric data associated with previously identified fraudulent transactions; determining, using the programmed computer processor, whether the transaction request is identified as a fraudulent transaction, at least based on the comparison; upon determining that the transaction is fraudulent, generating, using the programmed computer processor, an alert indicating that the transaction request is associated with fraud; preventing, using the programmed computer processor, the transaction associated with the transaction request from being conducted; and updating, using the programmed computer processor, the one or more negative fraud credentials with the collected credential data.

According to another embodiment of the present invention, a system comprises: a network, a user device, wherein the user device is communicatively coupled to the network; a processor, wherein the processor is communicatively coupled to the network; and a memory comprising computer-readable instructions which when executed by the processor cause the processor to perform the steps comprising: receiving, using a programmed computer processor, a communication from a customer device, wherein the communication comprises a transaction request; determining, using the programmed computer processor, whether the transaction request is identified as a fraudulent transaction; additionally determining, using the programmed computer processor, whether the transaction request is identified as a suspicious transaction; upon determining that the transaction is fraudulent or suspicious, collecting, using the programmed computer processor, credential data associated with at least one of: the customer device, biometric data of a customer associated with the transaction request, and data associated with the transaction request; and storing, using the programmed computer processor, the collected credential data as one or more negative credentials, wherein the negative credentials comprise data associated with previously identified fraudulent transactions or previously identified as a suspicious transaction.

According to yet another embodiment of the present invention, a system comprises: a network, a user device, wherein the user device is communicatively coupled to the network; a processor, wherein the processor is communicatively coupled to the network; and a memory comprising computer-readable instructions which when executed by the processor cause the processor to perform the steps comprising: receiving, using a programmed computer processor, a communication from a customer device, wherein the communication comprises a transaction request; collecting, using the programmed computer processor, credential data associated with at least one of: the customer device, biometric data of a customer associated with the transaction request, and data associated with the transaction request; determining, using the programmed computer processor, whether the collected credential data corresponds to one or more customer profiles; generating, using the programmed computer processor, a fraud prediction model based on the corresponding one or more customer profiles; analyzing, using the programmed computer processor, results generated from the fraud prediction model; and determining, using the programmed computer processor, whether the collected credential data is predicted to correspond to a fraudulent transaction based on the analyzed results.

### BRIEF DESCRIPTION OF THE DRAWINGS

In order to facilitate a fuller understanding of the present inventions, reference is now made to the appended drawings. These drawings should not be construed as limiting the present inventions, but are intended to be exemplary only.

FIG. 1 is an exemplary diagram of a fraud detection system in accordance with an exemplary embodiment.

FIG. 2 is an exemplary diagram of a fraud detection system for implementing negative credentials, according to an embodiment of the present invention.

FIG. 3 is an exemplary flowchart of a method for implementing the generation of negative credentials, and a black list of negative credentials, according to an embodiment of the present invention.

FIG. 4 is an exemplary flowchart of a method for implementing the application of negative credentials, according to an embodiment of the present invention.

FIG. 5 is an exemplary flowchart of a method for implementing the application of predictive negative credentials, according to an embodiment of the present invention.

### DESCRIPTION OF EMBODIMENTS OF THE INVENTION

It will be readily understood by those persons skilled in the art that the various embodiments described herein are capable of broad utility and application.

Exemplary methods are provided by way of example herein, as there are a variety of ways to carry out the method disclosed herein. The methods depicted in the Figures may be executed or otherwise performed by one or a combination of various systems, such as described herein. Each block shown in the Figures represents one or more processes, methods, and/or subroutines carried out in the exemplary methods. Each block may have an associated processing machine or the blocks depicted may be carried out through one processor machine. Furthermore, while the steps may be shown in a particular order, it should be appreciated that the steps may be conducted in a different order.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read-only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer-based network. The computers may have software installed thereon configured to execute the methods of the exemplary embodiments. The software may be in the form of modules designed to cause a computer processor to execute specific tasks. The software may be stored on a tangible, non-transitory computer-readable medium. The computers may be configured with hardware to execute specific tasks. As should be appreciated, a variety of computer-based configurations are possible.

An embodiment of the present invention is directed to applying negative credentials, such as biometrics, in fraud analysis by creating a “black list” of known (or likely) fraudsters. When a fraudulent transaction is identified, according to an embodiment, a system may collect various forms of identification and/or other information to identify the fraudster and thereby create a negative digital footprint profile. The collected information may include, but is not limited to, biometric information that accurately identifies an individual, such as voice file, fingerprints, handprints, facial recognition, etc. Other biometric information that may be helpful in identifying and/or confirming a fraudster may include speech pattern, location data, key logging, key stroke pattern, typing speed and/or typing pattern, behavioral data, mannerisms, etc. An embodiment of the present invention may also rely on other information (not directly related to biometrics), which may include IP address, telephone number, area/location of transaction (e.g., pay phone, motel room, high risk area, proximity to known fraudsters, etc.), transaction mechanism (e.g., pre-paid mobile phone), type of fraud (e.g., high dollar amount), similarity to a fraud pattern, etc. Other information may include other types and forms of interactions. The negative profile may be applied to identify fraudsters during a transaction and also verify customers who do not fit the negative profile.

An embodiment of the present invention may take a known fraudulent contact and generate a fraud identifier that uniquely identifies that person (e.g., phone number, IP address, voice recognition, etc.). An embodiment of the present invention may also use the information to generate a fraud profile (e.g., type of contact, dollar amount/range, requested transaction, geographic location, etc.). The fraud profile may be used to identify similar types of fraudulent activity as well as related fraudulent activity. For example, that fraudster may be part of a larger operation where other fraudsters are conducting similar types of fraudulent transactions. Accordingly, the negative biometric may include a list of fraud identifiers and/or various fraud profiles.

According to an exemplary scenario, a fraudster may contact the bank and make a fraudulent transaction. The system, in an embodiment, may then pull that voice file and generate a known fraud voice biometric. Thereafter, according to an embodiment, the system may then use that known fraud voice biometric and compare it to other voice interactions to determine if the voice prints match. According to another example, the system may apply a negative biometric to certain types of transactions. For example, the system may determine whether a transaction is a risky transaction (e.g., high dollar amount, calling from an unfamiliar number, etc.). The system of an embodiment of the present invention may then apply a negative biometric to the high risk transactions (or other types of transactions that require an additional check). Other identifying information may be applied, which may include voice pattern (e.g., accent, unique speech patterns, use of words, etc.), location data, keystroke pattern, typing speed, swipe pattern, mouse click pattern, etc.

According to an exemplary scenario, the system of an embodiment of the present invention may apply the negative biometric, which may include a list of fraud identifiers and/or various fraud profiles. The negative biometric may be applied at every contact. Also, the negative biometric may be applied in response to certain flags (e.g., high risk area, call from a public phone, etc.).

The embodiments of the present invention may be applied to customers of an entity (e.g., financial institution, merchant, service provider, etc.). The embodiments of the present invention may also be applied to internal workers, such as employees (or contactors, affiliates, subsidiaries, etc.) of an entity. The system and method of an embodiment of the present invention may be applied to detect cheating, stealing, aiding fraudsters, etc.

According to another example, a customer may initiate a contact with the bank. The bank may apply a negative biometric to the contact. If the result shows a high risk, the bank may alter an authentication mode to a higher more secure mode. The authentication mode may be altered on-the-fly during a transaction. Also, according to another example, if the system is unable to extract sufficient information, the system may switch to another form of verification. For example, if the system is attempting to extract a voice print but the connection is unclear, the system may switch to another form of authentication, such as verification of the phone number and geographical location.

An embodiment of the present invention may also gather additional identifying information from websites and public sources, including social media, data aggregators, search engines, etc. Other information may include merchant interactions, geographic location, travel history, behavior data, peer data, etc.

According to an embodiment of the present invention, a general fraudster profile that represents a composite from more than one fraudster or type of fraudster may be generated. This biometric profile may then be used to identify risk levels of fraud, e.g., low, medium, high, etc.

An embodiment of the present invention may also include a predictive component that uses information from the negative biometrics and other data and determine whether a transaction is likely fraudulent based on a degree of similarity and/or proximity to the negative biometric.

The computer implemented system, method and medium described herein can provide the advantage of accurately identify fraudsters and thereby mitigate losses caused by fraud, according to various embodiment of the invention. Additionally, the embodiments of the present invention may increase accuracy related to identifying fraudsters and fraudulent activity. For example, the features of the invention may increase the fraud detection rate, such as the number of instances of true fraud and/or fraudsters that are positively detected by the fraud detection mechanisms. In yet another embodiment, the fraud detection mechanisms may function to decrease the false alarm rate, namely instances of normal activity and/or normal customers that are erroneously identified as fraudulent may be reduced. Furthermore, an embodiment of the present invention may employ fraud prevention mechanisms which block, or otherwise avert, an identified fraudulent activity and/or predicted fraudulent activity from being conducted. As a result, transactions that are associated with fraud, such as theft, may be thwarted by the embodiment of the present invention. Accordingly, various advantages related to protecting customers and their assets may include decreasing the amount of false alarms associated with the activities of customers in good standing, and increasing customer confidence.

Other embodiments, uses, and advantages of the invention will be apparent to those skilled in the art from consideration of the specification and practice of the invention disclosed herein. The specification and examples should be considered exemplary only, and the scope of the invention is accordingly not intended to be limited thereby.

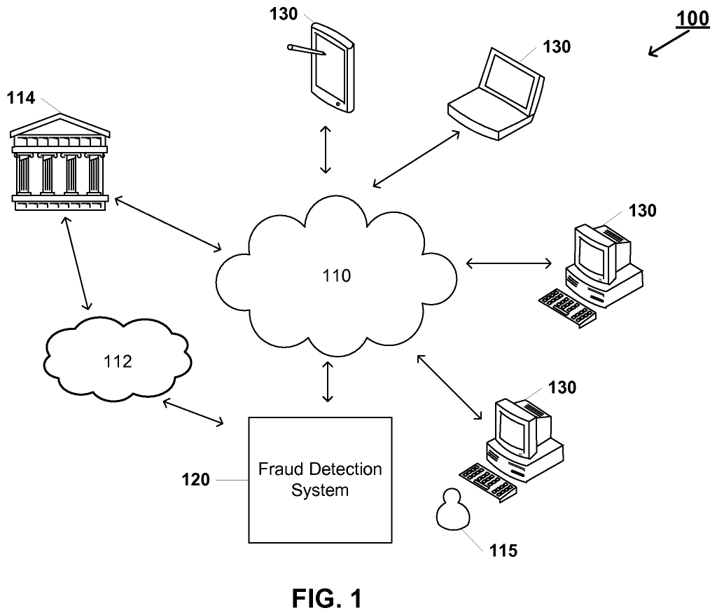

FIG. 1 is an exemplary diagram of a fraud detection system according to an exemplary embodiment of the present invention. The system 100 may provide various functionality and features of a fraud detection system. Furthermore, according to an embodiment, the system 100 may be provided by an entity, such a financial institution 114, according to an embodiment. In an exemplary embodiment, the system 100 depicts the hardware configuration of devices within the financial institution 114. The system may include an internal communications network 112, an external communications network 110, one or more user devices 130, a user 115, and Fraud Detection System 120.

According to an exemplary embodiment, Fraud Detection System 120 may be connected to an internal communications network 110 and an external network 110. The communications network 112 may be a computer-based network that is established, or otherwise made available within the financial institution 114. The communication network may include one or more servers and/or computer processors. The communications network 110, may be a network made available outside of, or externally to, the financial institution. In an embodiment, the external communications network 110 may be supported by a service provider that is not the financial institution. For example, the network may be a wide area network (WAN), such as the Internet or a network connected to the Internet. The network may be a satellite or cellular-based network. Information and data may be exchanged through the network between the various devices. Furthermore, the communications network may be a local area network (LAN), such as an intranet. It should be appreciated that the network may be a combination of local area networks, wide area networks, and external networks, which may be connected to the Internet.

In accordance with exemplary embodiments, a plurality of user devices 130 may be connected to communications network 110. Each user device 130 may be a computing device that enables communication between a user 115 and the financial institution 114 to perform a plurality of transactions on behalf of the user, such as purchases, account deposits, account withdrawals, account inquiries, and the like. For example, a user may be a group (e.g., married couple, family, etc.) or individual that has an established relationship with the host of the fraud detection mechanisms, such as a financial institution, merchant, or the like. According to an exemplary embodiment, the user may establish a relationship by being a customer, account holder, or attempting to conduct a transaction communication with the financial institution. In other embodiments, the user may not be a previous customer of, or have a pre-established relationship with, the financial institution. For instance, the user may be a new customer or a potential customer. The user device 130, according to some embodiments, may be a personal computer such as desktop computer, running software which facilitates communication with the financial institution.

Each customer device 130 may be a “fat” client, such that the majority of the processing may be performed on the client. Alternatively, the customer device 130 may each be a “thin” client, such that the majority of the processing may be performed in the other components of the system 100 as best shown in FIG. 1. The customer devices 130 may be configured to perform other functions and processing beyond the methods described herein. The customer devices 130 may each be a part of a larger system associated with the financial institution. The customer devices 130 may be multi-functional in operation. The customer device 130 may each support the operation and running of one or more applications or programs.

Each customer device 130 may have a display and an input device associated therewith. The display may be monochrome or color. For example, the display may be a plasma, liquid crystal, or cathode ray tube type display. The displays may be touch screen type displays. The customer device 130 may have more than one display. The multiple displays may be different types of displays. The display may have sub-displays there on. For example, the customer device 130 may have a large display surface. The display for the user interface may occupy a portion or less than the whole of the large display surface.

The input device may be a single device or a combination of input devices. For example, the input devices may include a keyboard, both full-sized QWERTY and condensed, a numeric pad, an alpha-numeric pad, a track ball, a touch pad, a mouse, selection buttons, and/or a touch screen. As described above, the display may serve as an input device through using or incorporating a touch screen interface. The customer device 130 may include other devices such as a printer and a device for accepting deposits and/or dispensing currency and coins.

The customer device 130 may have one or more cameras, optical sensors, biometric sensors, and other sensing devices. The sensors may be computer controlled and may capture data that can be further employed to identify the customer, such as digital images, fingerprints, physical biometric data, and the like.

According to some embodiments, the customer devices 130 may be portable electronic devices or mobile electronic devices. The user may interact with the portable electronic device through various input means (not shown). For example, the portable electronic device may have a display screen to convey information to the user. The display may be a color display. For example, the display may be a Liquid Crystal Display (“LCD”). The portable electronic device may have one or more input devices associated with it. For example, the portable electronic device may have an alpha-numeric keyboard, either physical or virtual, for receiving input. The portable electronic device may have a QWERTY style keyboard, either physical or virtual. The portable electronic device may have a pointing device associated therewith, such as, for example, a trackball or track wheel. The portable electronic device may receive inputs through a touch screen or other contact interface. In some embodiments, gesture based input may be used. A combination of input types may used. As described above, the portable electronic device may have communication capabilities over both cellular and wireless type networks to transmit/receive data and/or voice communications.

The portable electronic device, by way of non-limiting examples, may include such portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablets, or other portable computing devices. These portable electronic devices may communicate and/or transmit/receive data over a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable electronic device. The portable electronic device may use standard wireless protocols which may include IEEE 802.11a, 802.11b, 802.11g, and 802.11n. Such portable electronic devices may be Global Positioning System (GPS) capable. GPS is a satellite based system which sends a signal allowing a device to define its approximate position in a coordinate system on the earth. That is, the portable electronic device may receive satellite positioning data and display the location on the earth of the portable electronic device using GPS. Other location systems may be used. The portable electronic device may include one or more computer processors and be capable of being programmed to execute certain tasks. The customer device 130 may establish communications with other parts of the system 100 over a network 110. Upon successful initiation of communications between the and the network 110 and another part of the system 100, data may be exchanged between the devices over the network 110. Data may be transmitted from customer devices 130 and fraud detection system 120.

The customer devices 130 may have a log-in device associated therewith. The log-in device may be used to allow access to the device. The log-in device may require a particular input or it may accept a combination of inputs. The input may serve as an authentication of the user to the customer device 130 and, in some embodiments, the system 100 in general. Various authentication or log-on systems and methods may be used. For example, these methods and systems may include entering a password or PIN (Personal Identification Number) or using a card to log-on, either via swiping the card through a reader, such as a magnetic stripe reader or a smart chip reader, or through a radio frequency system (which may require that the card be placed in proximity to an appropriate reader (i.e., a contactless system), such as, for example, RFID (Radio Frequency Identification) or NFC (Near Field Communications). It should be appreciated that the card may include a combination of a magnetic stripe, a smart chip, and radio frequency. Further, the use of the card is exemplary only and the card may include fobs, stickers, and other devices. Biometrics may be used, such as fingerprints, facial recognition, speech recognition, palm vein scan, or retinal scan. A combination of these systems may be used. Biometrics may be used in addition to other log-in methods and systems.

According to an embodiment of the present invention, Fraud Detection System 120 may accurately identify fraudulent activity, and further use the identified fraud to prevent subsequent fraudulent activity, or fraudsters, from conducting subsequent transactions. According to an exemplary embodiment, a fraud detection system may identify a transaction as fraud, and thereafter collect biometric data associated with the particular customer, such as facial recognition data. The collected biometric data may be stored at a database that is maintained by Fraud Detection System 120, the biometric data may include negative credentials associated with fraud. The negative credentials may be applied to current transactions to further identify a customer as fraudster in a subsequent communication with the Financial Institution 114 or other entity. Fraud Detection System 120 may be interconnected to one or more customer devices 130 via network 110. In an embodiment, Fraud Detection System 120 may be stand alone or hosted by an entity, such as a financial institution, service provider, corporation, company, facility, merchant, bank, etc. For example, Fraud Detection System 120 may be affiliated or associated with a host entity and/or other entity. Fraud Detection System 120 may operate to directly receive communication from the customer devices 130 that may be transmitted to the financial institution 114. In an another embodiment, Fraud Detection System 120 may passive monitor, or otherwise track, commination destined to the financial institution 114.

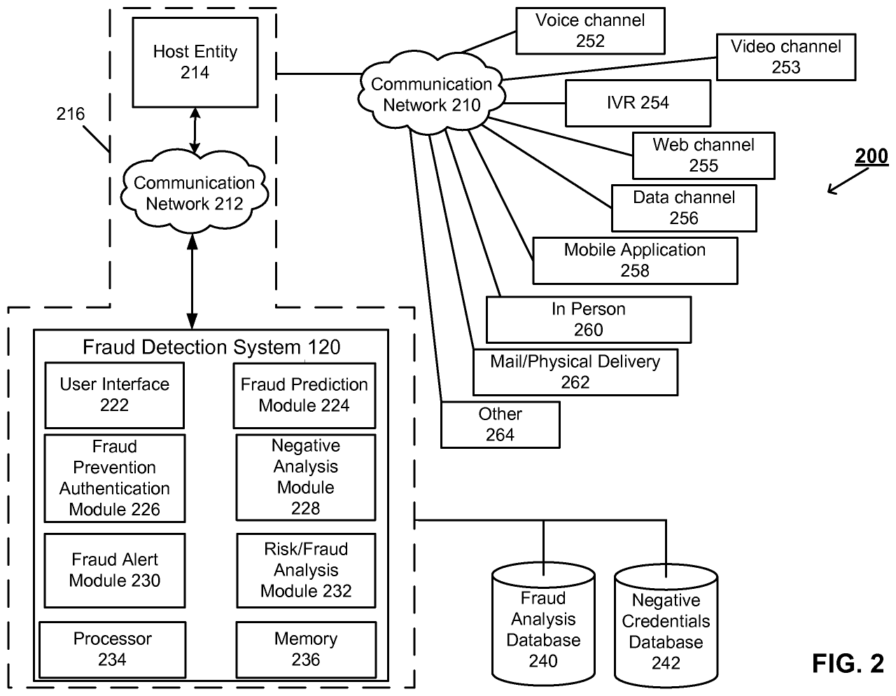

FIG. 2 illustrates an exemplary diagram of a fraud detection system for monitoring and/or detecting fraudulent transactions, according to an embodiment of the present invention. Components of the system 200 may include a host entity 214, and a Fraud Detection System 120.

In an exemplary embodiment, a Host Entity 214 may host or support a Fraud Detection System 120. In this example, the implementation of negative credentials of an embodiment of the present invention may appear to be performed by a host entity, as a single consolidated unit, as shown by 216. According to another example, Fraud Detection System 120 may be separate and distinct from Host Entity 214. For example, Host Entity 214, or other entity, may communicate to System 120 via a network or other communication mechanism, as shown by Communication Network 210.

In an embodiment, Fraud Detection System 120 may function to passively and/or actively monitor communication conducted between the Host Entity 214 and the communication network 210. For example, Fraud Detection System 120 may monitor a network-based communication that contains a request to conduct a financial transaction, such as a purchase. According to an embodiment of the present invention, Fraud Detection System 120 may intercept traffic communicated, conveyed, or transmitted via the communication network 210 and/or communication network 210. For instance, Fraud Detection System 120 may capture packets comprising a network data stream, that is transmitted to and/or communicated from the Host Entity. Fraud Detection System 120 may implement the traffic monitoring capabilities as a packet analyzer, packet sniffer, protocol analyzer, wireless sniffer, and the like. According to an embodiment of the present invention, Fraud Detection System 120 may be implemented to monitor traffic that has been isolated, or otherwise separated, from the Host Entity. Fraud Detection System 120 may function as a honeypot, for example, in order to perform detection mechanisms without adversely effecting other components of the Host Entity system.

Fraud detection system 120 also be in communication with various branch or remote locations, including affiliates, subsidiaries, and others. According to an exemplary application, Fraud detection system 120 may be integrated with a Financial Institution and branch locations may represent branch offices, ATMs, kiosks, merchant locations, etc.

Fraud Detection System 120 may access databases and/or other sources of information to make determinations and perform analysis. Fraud Detection System 120 may access and/or maintain Fraud Analysis Database 240, Negative Credentials Database 242 and other Databases or other forms of memory/storage.

Fraud Analysis Database 240 may store, maintain, and manage information corresponding to fraud. In an exemplary embodiment, the Fraud Analysis Database may store and/or manage a plurality of negative fraud credential profiles. A negative fraud credential profile may include user identification information that may be used to identify a fraudster, for example, demographic information, user preferences, user biometric data, location data, address etc. Negative fraud credentials may further include data associated with a particular customer device employed by a fraudster, such as a computer Internet Protocol address (IP address). The system of an embodiment of the present invention may store fraudulent devices (e.g., mobile phone, computer, laptop, tablet devices, gaming console, etc.); fraudsters (e.g., name, face, account number, etc.) and/or other information. A negative fraud credential profile may also include activity data that further corresponds to a fraudster, such as prior history, prior transactions, transaction trends, type of transactions, transaction amounts, and the like. Also, the Fraud Analysis Database may maintain and store a “black list” of negative credentials. The “black list” may be comprised of the negative credential profiles, negative credentials, or other identifiers (e.g., name) that may be associated with known fraudsters. According to an exemplary embodiment, information in the Fraud Analysis Database 240 may be confirmed by a trusted entity, such as a third party authenticator, as being fraudulent and/or a fraudster prior to being stored, thereby reducing the potential of false positives of fraud.

Negative Credentials Database 242 may maintain and manage negative credentials for various users. In an exemplary embodiment, the Negative Credentials Database 242 may store a plurality of negative credentials, and negative credential profiles. A negative credential profile may include user identification information that may be used to identify a fraudster or a customer that is as suspected fraudster. Negative credentials may comprise customer identification information, for example, demographic information, user preferences, user biometric data, location data, etc. A fraud credential profile may also include activity data that further corresponds to a fraudster, such as prior history, prior transactions, transaction trends, type of transactions, transaction amounts, social media information, personal history (e.g., divorce), financial history (e.g., bankruptcy), and the like. According to an exemplary embodiment, information in the Negative Credentials Database 242 may not require confirmation by a trusted entity, so as to be further employed in fraud determination analysis. Negative Credentials Database 242 may also store predefined rules, parameters, and other information that may be used to identify fraudsters and/or fraudulent transactions, for example. In an exemplary embodiment, the Negative Credentials Database 242 may maintain default negative credentials and/or negative credential profiles. The default negative credentials may comprise one or more predefined credentials that may be determined by a trusted entity as corresponding to suspicious and/or fraudulent activity. The default negative credentials may include one or more predefined credentials which identify suspicious and/or fraudulent customers.

While individual databases are illustrated in the exemplary figure, the system may include multiple databases at the same location or separated through multiple locations. The databases may be further combined and/or separated. In addition, the databases may be supported by Host Entity 214 or an independent service provider. For example, an independent service provider may support the one or more databases and/or other functionality at a remote location. Other architectures may be realized. The components of the exemplary system diagrams may be duplicated, combined, separated and/or otherwise modified, as desired by various applications of the embodiments of the present invention as well as different environments and platforms.

Fraud Detection System 120 may include various modules, interfaces and/or processors for implementing negative credentials, according to an embodiment of the present invention. In the embodiments, Fraud Detection System 120 may include User Interface 222, Fraud Prediction Module 224, Fraud Prevention Authentication Module 226, Negative Analysis Module 228, Fraud Alert Module 230, Risk/Fraud Analysis Module 232, Processor 234, and Memory 236, and/or other modules, interfaces and/or processors. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

According to another embodiment of the present invention, Fraud Detection System 120 may host a website or other electronic interface where users may access data as well as provide data. For example, a user may submit and access information through User Interface 222 to view data, submit requests, provide data and/or perform other actions. Fraud Detection System 120 may communicate with various entities via communication network 210.

Fraud Prediction Module 224 implements mechanisms that are used to resultantly predict whether a user, based on observed behavior, for example, may be a fraudster. Fraud Prediction Module 224 may generate a prediction model associated with an analyzed user and/or activity. Thereafter, Fraud Prediction Module 224 may conduct further analysis using the generated model to predict fraudulent activity and/or users. In some embodiments, Fraud Prediction Module 224 may transmit, or otherwise convey, the determined prediction to the Negative Analysis Module 228. Accordingly, the Fraud Prediction Module 224 may provide one or more predictions that can be applied as input to be analyzed during the fraud detection functions of the system.

Fraud Prevention Authentication Module 226 controls and maintains the various user authentication capabilities of Fraud Detection System 120. For example, the Fraud Prevention Authentication Module 226 may, via the User Interface 22, request and receive user credential input (e.g., username, biometric data, password, etc.). Thereafter, Fraud Prevention Authentication Module 226 may further determine whether to deny or allow user access, based on the received credentials. In an exemplary embodiment, the Fraud Prevention Fraud Prevention Authentication Module 226 may further request that additional credential information be provided from a user, in the instance where a user is identified as suspicious and/or a potentially fraudster. Also, Fraud Prevention Fraud Prevention Authentication Module 226 may prompt a user to enter additional credential information in the event that the requested transaction is identified as a suspicious and/or a potentially fraudulent activity.

Fraud Prevention Authentication Module 226 may operate to, based on a determination of fraud, determine whether additional or alternate authentications should be applied. This analysis may also involve receiving and/or analyzing data from other sources, e.g., credit bureaus, third party fraud services, government entities, etc. This analysis may also include industry specific data and/or factors.

Negative Analysis Module 228 controls and conducts the generation of negative credentials. Negative Analysis Module 228 may communicate with the Fraud Analysis Database 240 and Negative Credentials Database 242 to maintain the plurality of negative credentials and profiles compiled and employed by the system.

Fraud Alert Module 230 is directed to generating, communicating and/or displaying an alert, message, warning and/or other communication. For example, the alert may indicate that a user has been identified as suspicious or a fraudster. Other conditions may be identified as well. Additionally, an alert may indicate that a requested transaction is identified as a suspicious and/or a potentially fraudulent activity. Fraud Alert Module 230 may produce and convey an alarm or other audio and/or visual indicator may sound to provide an alert to the problem. For example, Fraud Alert Module 230 may transmit the alert to a device associated with a trusted entity, such a bank employee.

Risk/Fraud Analysis Module 232 processes information from various other components of Fraud Detection System 120 (and/or other external sources of data) to determine whether a user and/or activity is identified as being associated with fraud. In some embodiments, Risk/Fraud Analysis Module 232 may analyze automated information, e.g., negative credentials and prediction models, that are generated by the system and/or other sources. For example, Risk/Fraud Analysis Module 232 may receive input from a trusted source external to Fraud Detection System 120, such as a computer terminal associated with a bank employee. In this example, the received input may indicate that the user and/or activity is suspicious, fraudulent, normal and/or other condition. The received external, or human, input may be analyzed with the automated information by the Risk/Fraud Analysis Module 232. In some instances, the received external input may supersede system data to indicate that the user and/or activity is suspicious, fraudulent, or normal (e.g., override).

Fraud Detection System 120 may be accessed via various modes of communication. For example, a user may communicate via a Communication Network 210 through a voice channel 252, a video channel 253, IVR channel 254, web channel 255, data channel 256, mobile application 258, etc. Other forms of communication may also include in-person 260, mail/physical delivery 262 and other mode of communication or interaction represented by 264. For example, during an in-person contact at a merchant location, biometric data may be obtained at check-out or other location in and/or around the merchant location. For a mail delivery, a customer's handwriting sample may be obtained and analyzed. Other types of customer contact may be identified and implemented in accordance with the various embodiments of the present invention.

Processor 234 may be configured to control the functions of Fraud Detection System 120. Processor 234 may execute software, firmware, and computer readable instructions stored in memory 236, such that the capabilities of Fraud Detection System 220 are implemented according to exemplary embodiments. Memory 236 may include non-volatile and/or volatile memory.

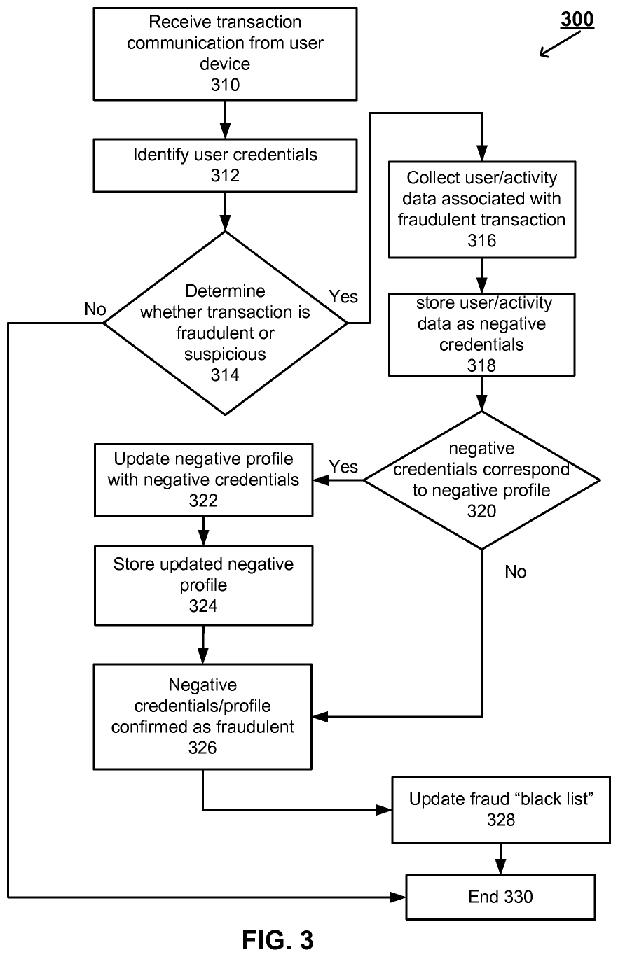

FIG. 3 depicts a flow chart of a method employed for generating one or more negative credentials according to an exemplary embodiment of the present invention. The method 300 as shown in FIG. 3 may be executed or otherwise performed by one or a combination of various systems and devices, such as the system of FIG. 3. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At block 310, a communication from a customer device may be received by an embodiment of the present invention. The communication may be generated by one or more customer devices as depicted in FIG. 1, and transmitted via a communications network. A customer device may include any mechanism capable performing electronic, network based, voice, or visual communication with a hosting entity. In another embodiment, the communication may be received in one of the channels as depicted in FIG. 2. The communication may comprise a transaction, transaction request, or any other information that may be related to conducting an activity with the entity hosting the system.

At block 312, user credentials associated with the customer initiating the transactions may be identified. For example, the customer may be required to log in to an application that supports transaction communication capabilities, e.g., a banking website. The login may be conducted using any number of methods, including biometrics, a username/password, a combination of login methods, etc. For example, biometrics and an entry code may be required. The system may, extract, or otherwise parse the information received during log in, so as to identify the customer's credentials.

At block 314, an embodiment of the present invention may determine whether the transaction associated with the communication of step 310 is fraudulent or suspicious. Other conditions may be identified as well. The determination may be made by receiving input from a trusted entity, such as an authentication service, administrator, or employee. For example, a financial institution employee may a flag a requested withdrawal as fraudulent or suspicious. The input may be received by a device associated with the trusted entity. Thereafter, the transaction may be identified as fraudulent or suspicious, based on the input from the trusted entity. In another embodiment, the determination may be performed by the fraud prediction module 224, which may provide a prediction that the transaction is fraudulent or suspicious, based on the customer's credentials. According to an exemplary embodiment, risk/fraud analysis module 232 may accomplish the fraud determination using the customer's credentials and the negative credentials stored by the system (e.g., fraud analysis database).

In the event that the transaction is determined to not be fraudulent, and not suspicious, at step 314, the transaction may be deemed normal activity and ends at step 330. According to the embodiments, normal activity may be any scenario involving a transaction that is not otherwise considered as fraudulent and/or suspicious. Normal activity may include, but is not limited to, transactions conducted by an authorized customer, transactions conducted using a secure customer device, and the like.

An embodiment of the present invention may determine that the transaction is fraudulent and/or suspicious, and subsequently proceeds to step 316. At block 316, the system may collect user data and/or activity data associated with the fraudulent transaction. For example, a fraud detection system may collect data from the user or customer device involved with the fraudulent transaction. The collected data may include personal data that may be used to identify the customer as an individual, or customer device data that may identify the device associated with the customer. For example, a fraud detection system may collect biometric data, such as a fingerprint or facial imagery, from one or more biometric capable devices incorporated in the customer device. In another embodiment, a fraud detection system may generate a digital footprint from customer device data, either passively or actively, associated with the fraud. For instance, a fraud detection system may collect, and subsequently store, a digital footprint comprising key strokes, cookies, IP address, etc. of the customer device at the time the fraudulent activity was positively identified.

Collected data may include information used to accurately identify customer, biometric data such as voice file, fingerprints, handprints, facial recognition, etc. Other biometric information may include speech pattern, location data, typing speed/pattern, behavioral data, mannerisms, etc. In another embodiment, the user data may include log in or credential based user data, such as name, username, password, and the like.

In addition, an embodiment of the present invention may receive data corresponding to the fraudulent activity, such as area/location of transaction (e.g., pay phone, motel room, high risk area, proximity to known fraudsters, etc.), transaction mechanism (e.g., pre-paid mobile phone), type of fraud (e.g., high dollar amount), etc. According to exemplary embodiments, any combination of user data and transaction data may be collected by the system of the invention.

At block 318, the collected user data and/or activity data may be stored or maintained as negative credentials. The negative credentials may be stored and maintained in a storage, memory, or data structure of the system, such as the negative credentials database, for example.

At block 320, an embodiment of the present invention may determine whether the newly stored negative credentials correspond to previously stored negative profile. An embodiment of the present invention may perform the determination by comparing the negative credentials associated with the current instance of fraud, with one or more previously stored negative credentials profiles and/or credentials. In an exemplary embodiment, multiple instances of fraud may be determined, and thereafter maintained in a profile, for a shared parameter. For instance, an embodiment of the present invention may recognize that a username “johndoe123” also corresponds to one or more previously stored negative credential profiles. The system may further utilize this capability to consider a trend of fraudulent activity corresponding to particular negative credentials.

In the event that a corresponding negative credential profile is identified, the process may proceed to block 322 and update the corresponding negative credential profile with the newly identified negative credentials. For example, an embodiment of the present invention may aggregate, and store, negative credentials collected from the current fraud transaction by the username “johndoe123” into a negative credential profile of previously stored instances of fraud for “johndoe123.”

At block 324, the updated negative credential profile may be stored. In an exemplary embodiment, the updated negative credential profile may be stored a database maintained by the system (e.g., negative credentials database). If no corresponding negative credential profile is determined in step 320, then the process proceeds to step 326.

At step 326, the system may confirm whether the stored negative credentials and/or negative credential profiles, which may be associated with only one or a few instances of suspected fraud, are indeed fraudulent. According to the embodiments, a fraud detection system may receive an externally generated confirmation input, which signifies that the negative credentials correspond to known, or otherwise verified, fraudsters and/or fraud activity. The confirmation input may be received from a device associated with a trusted entity, e.g., a financial institution employee computer. Also, the confirmation may be automated and generated automatically by the system based on one or more fraud confirmation factors. These fraud confirmation factors may include, but are not limited to, a fraud threshold (e.g., number of detected instances of fraud), confirmed fraud time period, fraud trends, predefined confirmed fraud credentials. Also, an embodiment of the present invention may significantly reduce inaccurate and false positives (e.g., normal customers identified as fraudsters) in the fraud detection mechanisms.

At block 328, after a negative credential and/or negative credential profile has been confirmed as corresponding to known fraud, an embodiment of the present invention may update a “black list” on known fraudsters and/or fraud activity. For example, the “black list” may comprise one or more negative credentials or negative credential profiles that are validated by a system, or an entity trusted by the system, as an accurate and positive identification of fraud, fraudsters, or suspicious activity. The “black list” may be further employed in the fraud detection mechanisms of the invention to track subsequent transaction attempts from fraudsters in the “black list.”

At step 330, the “black list” generation process ends.

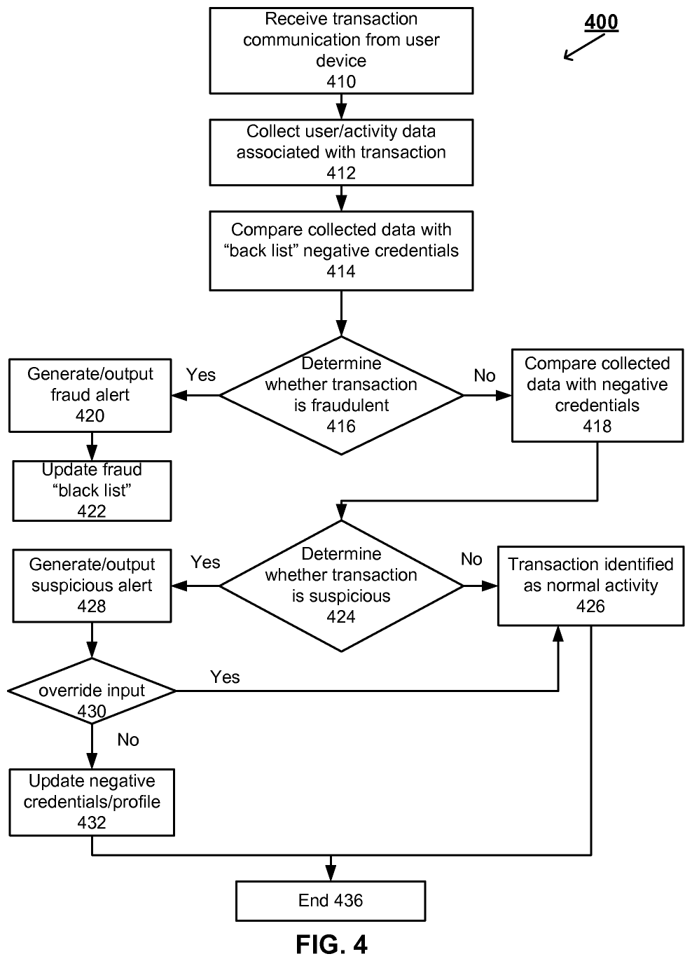

FIG. 4 depicts a flow chart of a method employed for applying negative credentials according to an exemplary embodiment of the present invention. The method 400 as shown in FIG. 4 may be executed or otherwise performed by one or a combination of various systems and devices, such as the system of FIG. 2. While the process of FIG. 4 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 410, a communication from a customer device may be received, via a communications network. The communication may be associated with a transaction requested by the customer associated with the device. In the illustrative example, the communication may be a transaction request for transferring funds from an account associated with a financial institution. For instance, a user may request to transfer $1,000 from an account associated with a first bank, to another account that is not related to, or unknown to, the first bank, for example.

At step 412, user data and activity data that corresponds to the received communication, namely the transfer of funds, may be collected. For example, an embodiment of the present invention may collect credentials (e.g., username, password) entered during log-in to a financial institution website, and facial recognition data (e.g., digital image) captured by a biometric sensor. According to the illustrative example, the user may enter a username of “fraudster” and a password of “12345” into a credential prompt generated by the embodiments of the present invention.

An embodiment of the present invention may interrogate the user device, and/or components of the user device, in order to further retrieve additional information relating to the user. For instance, a fraud detection system may interrogate a camera associated with the user's mobile device, in order to capture and transmit a digital image corresponding to the “fraudster” credentials entered.

At step 414, an embodiment of the present invention may compare the collected credentials, that is the user data and/or activity data (e.g., credentials and facial recognition data), to the negative credentials which comprise the “black list” maintained by the system. According to the illustrative example, at step 414, the username “fraudster,” the password “12345,” and the digital image may be compared to corresponding username, password, and facial recognition negative credentials comprising the “black list”.

Step 416, whether the collected credentials corresponds to a fraudster or fraud activity may be determined. For example, a comparison and determination may be performed by the risk/fraud analysis module 232, as depicted in FIG. 2. A determination may be made based on an exact or partial match between the collected credentials and the stored credential. A partial match may be any part, sequence, fragment, or section of data that is considered to be within an acceptable deviation from an exact match. In addition, a comparison may be implemented and performed as a text search, string search, boolean logic, visual data search, or any manner data-matching mechanisms that may be deemed necessary.

In the event that the transaction is determined to be fraudulent in step 416, the system proceeds to block 420. According to the illustrative example, the username “fraudster” may be determined to correspond to a username negative credential of the “black list”.

A fraud detection system of an embodiment of the present invention may generate, and thereafter output, an alert to indicate that the transaction is associated with a confirmed fraudster or involves fraudulent actions. In the illustrative embodiment, the alert may be implemented as an electronic message, for example an email, that is transmitted to a device associated with a trusted entity, such as financial institution employee. Any known or conventional forms of visual, audio, or multimedia alerts may be employed by the embodiments. Optionally, a fraud detection system of an embodiment of the present invention may prevent the transaction from being conducted. According to this embodiment, a fraud detection system may employ fraud prevention mechanisms of the present invention. For instance, a fraud detection system may block communication with the user device via the network, such as reconfiguring a firewall, to prevent further communication with the system and thereby preventing the transaction. According to the illustrative example, the user's mobile device may be deemed unauthorized to proceed in conducting the transfer of funds, and the user blocked from remotely accessing the banking system via a communications network.

At step 422, an embodiment of the present invention may update the fraud “black list” with the collected credentials corresponding to the detected fraud.

In the event that the transaction is not determined to be fraudulent, an embodiment of the present invention may proceed to step 418, and further compare the collected credentials with the stored negative credentials and/or negative credential profiles.

At step 424, an embodiment of the present invention may determine whether the transaction is suspicious. For example, a system of an embodiment of the present invention may provide another layer of security, in that although the transaction may not be fraud, the activity may be considered suspicious and further analyzed. The determination of this step is performed by the risk/fraud analysis module 232.

In the event that the transaction is not determined to be suspicious, a method of an embodiment of the present invention may proceed to step 426. At block 426, the transaction has been analyzed by the system and considered to be normal activity. Thereafter, the fraud detection ends at block 436.

In the event that the transaction is determined to be suspicious, then the method may proceed to step 428. At step 428, a fraud detection system of an embodiment of the present invention may generate, and thereafter output, an alert to indicate that the transaction is associated with a suspected fraudster or involves suspicious activity.

An embodiment of the present invention may request additional authentication information from the requesting customer, upon identifying a suspicious transaction in step 428. For instance, the customer may be prompted to input personal data (e.g., mother's maiden name, birthdate, etc.) to further authenticate the customer. The system may also iteratively request additional credentials from the customer, until a predetermined condition is satisfied (e.g., number of attempts, transaction is determined normal, user successfully authenticated). Fraud Prevention Authentication Module 226, may be employed to provide multi-level authentication mechanisms, based on the negative credentials.

At block 430, a system of an embodiment of the present invention may operate to receive an override input. For example, an exemplary fraud detection system may allow a trusted entity, such as financial institution employee, to override the fraud detection process associate with a suspicious activity. In the event that an override input is received by the system, an embodiment of the present invention may process the previously suspicious transaction, as normal activity. Thereafter, the fraud detection process ends in step 536. In the illustrative embodiment, the transfer of funds from the customer account is conducted.

Upon identifying that no override is received, an embodiment of the present invention may continue to process the transaction as suspicious, and proceeds to step 432.

At block 432, the negative credentials/negative credential profile may be updated with the new negative credentials associated with the suspicious activity. For example, the storage updates may be performed by the negative credential analysis module 228.

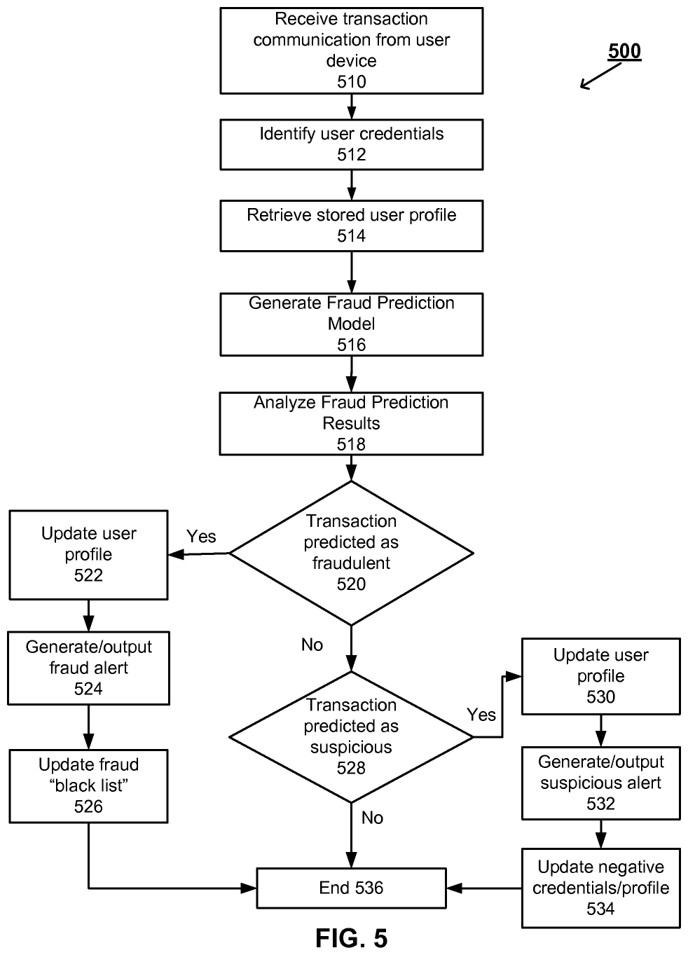

FIG. 5 depicts a flow chart of a method employed for predicting negative credentials according to an exemplary embodiment of the present invention. The method 500 as shown in FIG. 5 may be executed or otherwise performed by one or a combination of various systems and devices, such as the system of FIG. 2. While the process of FIG. 5 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At block 510, a transaction communication from a customer device may be received. At block 512, customer credentials may be identified. The customer credentials may be input by the customer during authentication process.

At block 514, an embodiment of the system may retrieve a customer profile that has been previously stored, and is considered to correspond to the customer requesting the transaction. For example, the customer profile may be stored by the database maintained by a fraud detection system of an embodiment of the present invention.

At block 516, a fraud prediction model may be generated based on the customer profile. An embodiment of the present invention may extract, or otherwise parse, data comprising the customer profile. The customer profile data may then be used as the variables, predictors, and parameters that are analyzed to generate the fraud prediction model. The fraud prediction model may be a statistical model which is further analyzed to forecast the behavior of the customer, based on the history and trends characterized by the customer profile. For example, the fraud prediction module may employ various predictive modelling techniques and/or algorithms, such as regression modelling and/or other techniques, to accomplish the functions of step 516. The generated predictive model, according to the embodiments, may be parametric or non-parametric.

At block 518, an embodiment of the present invention may analyze the resulting fraud prediction model to further predict a likelihood, such as a probability, that the received transaction corresponds to fraudulent or suspicious activity.

At block 520, an embodiment of the present invention may function to perform a predicted determination of whether the received transaction is predicted as fraudulent. For example, a system of an embodiment of the present invention may perform prediction based on patterns exhibited by the fraud predictive model and the forecasted future behavior of the customer. Based on the results of 518, an embodiment of the present invention may determine that the transaction is fraudulent, and then proceed to step 522.

In the event that the transaction is determined to be fraudulent, the system proceeds to block 522 and updates the customer profile.

At step 524, an embodiment of the present invention may generate, and thereafter output, an alert to indicate that the transaction is associated with a confirmed fraudster or involves fraudulent actions.

At step 526, an embodiment of the present invention may update the fraud “black list” with the collected credentials corresponding to the detected fraud. In some embodiments, the system may adaptively update the fraud prediction model based on the collected credential data. Thereafter, an embodiment of the present invention may be adaptively regenerated based on credential data, associated with the customer profile, that is received by the system.

In the event that the transaction is not determined to be fraudulent, the exemplary method may proceed to step 528.

At step 528, an embodiment of the present invention may perform a predicted determination of whether the transaction is suspicions. According to the embodiments, the predictive model may forecast the customer's behavior as suspicious, and then proceed to step 530 to update the customer profile. The determination of this step may be performed by Fraud Prediction Module 224.

At step 532, an embodiment of the present invention may generate, and thereafter output, an alert to indicate that the transaction is associated with a suspected fraudster or involves suspicious activity.

At block 534, an embodiment of the present invention may update the negative credentials/negative credential profile with the new negative credentials associated with the suspicious activity. Also, the storage updates are performed by the negative credential analysis module 228.

In the event that the transaction is not determined to be suspicious, the exemplary method of an embodiment of the present invention may proceed to step 536 and end.

Hereinafter, physical aspects of implementation of the exemplary embodiments will be described. As described above, exemplary methods may be computer implemented as a system. The system or portions of the system may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of, or in addition to, the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe, for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices, for example, capable of implementing the steps of the process.

It is appreciated that in order to practice the methods as described above, it is not necessary that the processors and/or the memories of the processing machine be physically located in the same geographical place. For example, each of the processors and the memories and the data stores used may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with further embodiments, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions. It is also appreciated that the data storage performed by two distinct components as described above may, in accordance with a further embodiment, be performed by a single component. Further, the data storage performed by one distinct component as described above may be performed by two distinct components. Further, various technologies may be used to provide communication between the various processors and/or memories, as well as to allow the processors and/or the memories of the various embodiments to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of various embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the various embodiments may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments. Illustratively, the programming language used may include assembly language, ActionScript, Ada, APL, Basic, C, C++, C#, COBOL, Ceylon, Dart, dBase, F#, Fantom, Forth, Fortran, Go, Java, Jquery, Modula-2, .NET, Objective C, Opa, Pascal, Prolog, Python, REXX, Ruby, Visual Basic, X10, and/or JavaScript, for example. Further, it is not necessary that a single type of instructions or single programming language be utilized in conjunction with the operation of the system and method of various embodiments. Rather, any number of different programming languages may be utilized as is necessary or desirable.

Also, the instructions and/or data used in the practice of the various embodiments may utilize any compression or encryption technique or algorithm, as may be desired. An encryption module might be used to encrypt data. Further, files or other data may be decrypted using a suitable decryption module, for example.

As described above, various embodiments may illustratively be embodied in the form of a processing machine, including a computer or computer system, for example, that includes at least one memory. It is to be appreciated that the set of instructions, e.g., the software, for example, that enables the computer operating system to perform the operations described above, may be contained on any of a wide variety of computer readable media, as desired. Further, the data, for example, processed by the set of instructions might also be contained on any of a wide variety of media or medium. For example, the particular medium, e.g., the memory in the processing machine, utilized to hold the set of instructions and/or the data used, may take on any of a variety of physical forms or transmissions. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the system.

Further, the memory or memories used in the processing machine that implements the various embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the various embodiments, a variety of “user interfaces” may be utilized to allow a user to interface with the processing machine or machines that are used to implement various embodiments. As used herein, a user interface includes any hardware, software, or combination of hardware and software used by the processing machine that allows a user to interact with the processing machine. A user interface may be in the form of a dialogue screen, for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is contemplated that the user interface might interact, e.g., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

While the various embodiments have been particularly shown and described within the framework of a Fraud Detection System, it will be appreciated that variations and modifications may be effected by a person of ordinary skill in the art without departing from the scope of the various embodiments. Furthermore, one of ordinary skill in the art will recognize that such processes and systems do not need to be restricted to the specific embodiments described herein. Other embodiments, combinations of the present embodiments, and uses and advantages will be apparent to those skilled in the art from consideration of the specification and practice of the various embodiments disclosed herein. The specification and examples should be considered exemplary.

Accordingly, while the various embodiments are described here in detail in relation to the exemplary embodiments, it is to be understood that this disclosure is only illustrative and exemplary and is made to provide an enabling disclosure. Accordingly, the foregoing disclosure is not intended to be construed or to limit the various embodiments or otherwise, to exclude any other such embodiments, adaptations, variations, modifications, and equivalent arrangements.

1. A system, comprising:
a network,
a user device, wherein the user device is communicatively coupled to the network;
a processor, wherein the processor is communicatively coupled to the network; and
a memory comprising computer-readable instructions which when executed by the processor cause the processor to perform the steps comprising:
establishing, via the network, a communication session with the user device;
receiving, via the network and using a programmed computer processor, a communication during the communication session, wherein the communication comprises a transaction request initiated by a computer;
collecting, via the network and using the programmed computer processor, credential data comprising each of: the customer device, biometric data of a customer associated with the transaction request, and data associated with the transaction request;
accessing, from a fraud database, a fraud black list comprising a plurality of validated negative fraud credentials and a plurality of fraud profiles, the plurality of validated negative fraud credentials comprising each of: a digital image associated with a plurality of known fraudulent devices; device identifier data for a plurality of known fraudulent devices; biometric data for a plurality of known fraudsters and a username and password combination associated with previously identified and validated fraudulent transactions, and the plurality of fraud profiles comprising at least a type of contact, a dollar amount or range for a requested transaction, a type of requested transaction, and a geographic location;
generating, using the programmed computer processor, a fraud prediction model to forecast customer behavior based on historical customer data and trends based on customer profile data;
applying the fraud prediction model to determine whether a transaction is fraudulent based at least in part on comparing, using the programmed computer processor, the collected credential data to the fraud black list to identify one or more similarities with known fraudulent behavior and generate a probability that the transaction is fraudulent;
upon determining that the transaction is fraudulent, generating, using the programmed computer processor, an alert indicating that the transaction request is associated with fraud;
preventing, using the programmed computer processor, the transaction associated with the transaction request from being conducted;
automatically updating, using the programmed computer processor, the one or more negative fraud credentials of the fraud black list with the collected credential data; and
if the transaction is determined not to be fraudulent, determining whether the transaction is suspicious and automatically updating the customer profile data.

2. The system of claim 1, further comprising:
one or more biometric sensors communicative coupled to the processor, wherein the one or more biometric sensors collect the biometric data of a customer associated with the transaction request.

3. The system of claim 1, further comprising:
a user interface communicatively coupled to the processor, wherein the user interface displays the alert indicating that the transaction request is associated with fraud.

4. The system of claim 1, wherein preventing the transaction further comprises terminating the communication session with the user device.

5. An automated computer implemented method for applying negative credentials, wherein the method is executed by a programmed computer processor which communicates with a user via a network, the method comprising the steps of:
establishing, via a network, a communication session with the user device;
receiving, via the network and using a programmed computer processor, a communication during the communication session, wherein the communication comprises a transaction request initiated by a computer;
collecting, via the network and using the programmed computer processor, credential data comprising each of: the customer device, biometric data of a customer associated with the transaction request, and data associated with the transaction request;
accessing, from a fraud database, a fraud black list comprising a plurality of validated negative fraud credentials and a plurality of fraud profiles, the plurality of validated negative fraud credentials comprising each of: a digital image associated with a plurality of known fraudulent devices; device identifier data for a plurality of known fraudulent devices;
biometric data for a plurality of known fraudsters and a username and password combination associated with previously identified and validated fraudulent transactions, and the plurality of fraud profiles comprising at least a type of contact, a dollar amount or range for a requested transaction, a type of requested transaction, and a geographic location;
generating, using the programmed computer processor, a fraud prediction model to forecast customer behavior based on historical customer data and trends based on customer profile data;
applying the fraud prediction model to determine whether a transaction is fraudulent;
comparing, using the programmed computer processor, the collected credential data to the fraud black list to identify one or more similarities with known fraudulent behavior and generate a probability that the transaction is fraudulent;
upon determining that the transaction is fraudulent, generating, using the programmed computer processor, an alert indicating that the transaction request is associated with fraud;
preventing, using the programmed computer processor, the transaction associated with the transaction request from being conducted;
automatically updating, using the programmed computer processor, the one or more negative fraud credentials of the fraud black list with the collected credential data; and
if the transaction is determined not to be fraudulent, determining whether the transaction is suspicious and automatically updating the customer profile data.

6. The method of claim 5, further comprising:
upon determining that the transaction is not fraudulent, additionally comparing, using the programmed computer processor, the collected credential data to one or more negative credentials, wherein the one or more negative credentials comprise biometric data associated with previously identified suspicious transactions; and
determining, using the programmed computer processor, whether the transaction request is identified as a suspicious transaction, at least based on the additional comparison.

7. The method of claim 6, further comprising:
upon determining that the transaction is suspicious, generating, using the programmed computer processor, an alert indicating that the transaction request is associated with suspected fraud; and
transmitting, using the programmed computer processor, a query to a device associated with a trusted entity, wherein the query requests input from the trusted entity to further determine whether the transaction request is associated with fraud.

8. The method of claim 5, wherein the one or more negative fraud credentials have been previously confirmed by a trusted entity as corresponding to fraud.

9. A system, comprising:
a network,
a user device, wherein the user device is communicatively coupled to the network;
a processor, wherein the processor is communicatively coupled to the network; and
a memory comprising computer-readable instructions which when executed by the processor cause the processor to perform the steps comprising:
receiving, using a programmed computer processor, a communication from a customer device, wherein the communication comprises a transaction request;
generating, using the programmed computer processor, a fraud prediction model that identifies one or more similarities to a negative fraud credential;
determining, using the programmed computer processor, whether the transaction request is identified as a fraudulent transaction responsive to the fraud prediction model;
additionally determining, using the programmed computer processor, whether the transaction request is identified as a suspicious transaction;
upon determining that the transaction is fraudulent or suspicious, collecting, using the programmed computer processor, credential data comprising each of: the customer device, biometric data of a customer associated with the transaction request, and data associated with the transaction request;
storing, using the programmed computer processor, the collected credential data as one or more negative credentials, wherein the negative credentials comprise data associated with previously identified fraudulent transactions or previously identified as a suspicious transaction; and
generating a fraud black list comprising a plurality of validated negative fraud credentials comprising each of: a digital image associated with a plurality of known fraudulent devices; device identifier data for a plurality of known fraudulent devices; biometric data for a plurality of known fraudsters and a username and password combination associated with previously identified and validated fraudulent transactions.

10. The system of claim 9, wherein the determining comprises receiving a prediction that the transaction request is fraudulent.

11. The system of claim 9, wherein the determining comprises receiving a prediction that the transaction request is suspicious.

12. The system of claim 9, wherein the determining comprises receiving input from a trusted entity, wherein the input indicates that the transaction request is fraudulent.

13. The system of claim 9, wherein the processor further performs:
receiving a confirmation that the collected credential data corresponds to fraud; and
updating a list of one or more negative fraud credentials.

14. A system, comprising:
a network,
a user device, wherein the user device is communicatively coupled to the network;
a processor, wherein the processor is communicatively coupled to the network; and
a memory comprising computer-readable instructions which when executed by the processor cause the processor to perform the steps comprising:
receiving, using a programmed computer processor, a communication from a customer device, wherein the communication comprises a transaction request;
collecting, using the programmed computer processor, credential data comprising each of: the customer device, biometric data of a customer associated with the transaction request, and data associated with the transaction request;
determining, using the programmed computer processor, whether the collected credential data corresponds to one or more customer profiles;
generating, using the programmed computer processor, a fraud prediction model based on the corresponding one or more customer profiles, the fraud prediction model determines whether the transaction request is fraudulent based on one or more similarities to a negative fraud credential; the negative fraud credential comprises biometric data associated with one or more previously identified fraudulent transactions;
analyzing, using the programmed computer processor, results generated from the fraud prediction model;
determining, using the programmed computer processor, whether the collected credential data is predicted to correspond to a fraudulent transaction based on the analyzed results; and
generating a fraud black list comprising a plurality of validated negative fraud credentials comprising each of: a digital image associated with a plurality of known fraudulent devices; device identifier data for a plurality of known fraudulent devices; biometric data for a plurality of known fraudsters and a username and password combination associated with previously identified and validated fraudulent transactions.

15. The system of claim 14, wherein the one or more customer profiles comprises a transaction history associated with the customer.

16. The system of claim 14, wherein the processor further performs: adaptively updating the fraud prediction model based on the collected credential data.

17. The system of claim 1, wherein the processor further performs: using the plurality of fraud profiles to identify related or similar transactions and generate a probability that the transaction is fraudulent.
